(19) United States
(12) Patent Application Publication
(10) Pub. No.: US 2022/0020124 A1
(43) Pub. Date: Jan. 20, 2022

(54) IMAGE PROCESSING METHOD, IMAGE PROCESSING DEVICE, AND STORAGE MEDIUM

(71) Applicant: Beijing Sensetime Technology Development Co., Ltd., Beijing (CN)

(72) Inventors: Zhe JIANG, Beijing (CN); Yu ZHANG, Beijing (CN); Dongqing ZOU, Beijing (CN); Sijie REN, Beijing (CN)

(21) Appl. No.: 17/489,636

(22) Filed: Sep. 29, 2021

Related U.S. Application Data
(63) Continuation of application No. PCT/CN2020/100236, filed on Jul. 3, 2020.

(30) Foreign Application Priority Data
Mar. 27, 2020 (CN) 202010232152.X

(51) Int. Cl. G06T 5/00; G06K 9/46; G06T 7/00

(52) U.S. Cl. CPC G06T 5/003; G06T 2207/30168; G06T 7/0002; G06K 9/4661

(57) ABSTRACT

The present disclosure relates to an image processing method, an imaging processing device and a storage medium. The method includes: acquiring a blurry image exposed in exposure time and event data sampled in the exposure time, wherein the event data is configured to reflect a luminance change of a pixel point in the blurry image; determining a global event feature in the exposure time according to the event data; and determining a sharp image corresponding to the blurry image according to the blurry image, the event data, and the global event feature.

### CROSS-REFERENCE TO RELATED APPLICATION

The present application is a continuation of and claims the priority to PCT Application No. PCT/CN2020/100236, filed on Jul. 3, 2020, which claims the priority to Chinese Patent Application No. 202010232152.X filed with China National Intellectual Property Administration, on Mar. 27, 2020, entitled “Image Processing Method and Apparatus, Electronic Device, and Storage Medium”. All the above reference priority documents are incorporated herein by reference in their entireties.

### TECHNICAL FIELD

The present disclosure relates to the technical field of computers, and more particularly, to an image processing method and apparatus, an electronic device, and a storage medium.

### BACKGROUND

During image acquisition, there is typically a relative motion between an image acquisition device and a photographed object to cause motion blur of images. Image deblurring is an important research trend in the computer vision and computer photography, and an important step indispensable for image quality enhancement and image restoration. This technique is widely applied to a variety of scenarios such as photographing, entertainment and video monitoring.

### SUMMARY

The present disclosure provides technical solutions for an image processing method and apparatus, an electronic device, and a storage medium.

According to one aspect of the present disclosure, there is provided an image processing method, which includes: acquiring a blurry image exposed in exposure time and event data sampled in the exposure time, wherein the event data is configured to reflect a luminance change of a pixel point in the blurry image; determining a global event feature in the exposure time according to the event data; and determining a sharp image corresponding to the blurry image according to the blurry image, the event data, and the global event feature.

According to one aspect of the present disclosure, there is provided an image processing device, which includes: a processor; and a memory configured to store processor executable instructions, wherein the processor is configured to execute the instructions stored in the memory, to execute the above image processing method.

According to one aspect of the present disclosure, there is provided a non-transitory computer-readable storage medium having computer program instructions stored thereon, wherein the computer program instructions, when executed by a processor, implement the above image processing method.

In the embodiments of the present disclosure, according to the event data sampled in the exposure time of the blurry image, a global event feature for reflecting scenario motion information in the exposure time may be determined, such that the sharp image corresponding to the blurry image and having high image quality may be obtained after a deblurring processing is performed on the blurry image based on the event data and the global event feature.

It will be appreciated that the above general descriptions and detailed descriptions below are only exemplary and explanatory and not intended to limit the present disclosure. Other features and aspects of the present disclosure will be apparent according to the following detailed description made on the exemplary embodiments with reference to the accompanying drawings.

### BRIEF DESCRIPTION OF THE DRAWINGS

The accompanying drawings, which are incorporated in and constitute a part of the present description, illustrate embodiments consistent with the present disclosure and serve to explain the technical solutions of the present disclosure together with the description.

FIG. 1 illustrates a flowchart of an image processing method according to an embodiment of the present disclosure.

FIG. 2 illustrates a schematic diagram of an image deblurring neutral network according to an embodiment of the present disclosure.

FIG. 3 illustrates a block diagram of an image processing apparatus according to an embodiment of the present disclosure.

FIG. 4 illustrates a block diagram of an electronic device according to an embodiment of the present disclosure.

FIG. 5 illustrates a block diagram of an electronic device according to an embodiment of the present disclosure.

### DETAILED DESCRIPTION

Various exemplary embodiments, features and aspects of the present disclosure are described in detail below with reference to the accompanying drawings. Reference signs in the drawings indicate elements with same or similar functions. Although various aspects of the embodiments are illustrated in the drawings, the drawings are unnecessary to draw to scale unless otherwise specified.

The term “exemplary” herein means “using as an example and an embodiment or being illustrative”. Any embodiment described herein as “exemplary” should not be construed as being superior or better than other embodiments.

The term “and/or” herein is only an association relationship for describing associated objects, which means that there may be three relationships, for example, A and/or B may mean three situations: A exists alone, both A and B exist, and B exists alone. Furthermore, the item “at least one of” herein means any one of a plurality of or any combinations of at least two of a plurality of, for example, “including at least one of A, B and C” may represent including any one or more elements selected from a set consisting of A, B and C.

Furthermore, for better describing the present disclosure, numerous specific details are illustrated in the following detailed description. Those skilled in the art should understand that the present disclosure may be implemented without certain specific details. In some examples, methods, means, elements and circuits that are well known to those skilled in the art are not described in detail in order to highlight the main idea of the present disclosure.

During image acquisition, there is typically a relative motion between an image acquisition device and a photographed object to cause the motion blur of images, for example, the image blur generated by jitter of the camera or movement of the scenario during photographing, the image blur generated by the vision system and the like of the aircraft, robot or autopilot due to the own quick movement, etc. The image processing method provided by the embodiments of the present disclosure may be used to perform an image deblurring operation on the blurry image obtained in the above application scenarios.

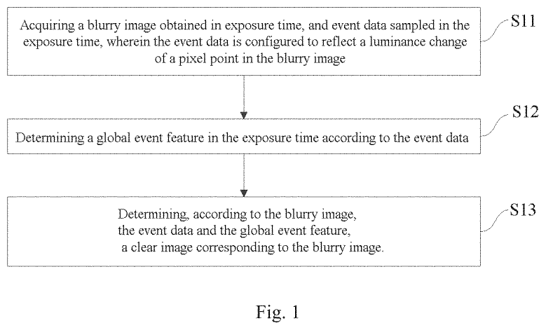

FIG. 1 illustrates a flowchart of an image processing method according to an embodiment of the present disclosure. The image processing method shown in FIG. 1 may be executed by a terminal device or other processing devices. The terminal device may be user equipment (UE), a mobile device, a user terminal, a terminal, a cell phone, a cordless phone, a personal digital assistant (PDA), a handheld device, a computing device, a vehicle-mounted device, a wearable device, etc. The other processing devices may be a server or a cloud server or the like. In some possible implementations, the image processing method may be implemented by enabling a processor to call computer-readable instructions stored in a memory. As shown in FIG. 1, the method may include steps S11-S13.

In step S11, a blurry image obtained in exposure time and event data sampled in the exposure time are acquired, where the event data is configured to reflect a luminance change of a pixel point in the blurry image.

In step S12, a global event feature in the exposure time is determined according to the event data.

In step S13, a sharp image corresponding to the blurry image is determined according to the blurry image, the event data, and the global event feature.

The blurry image may be acquired by an image acquisition device (such as a camera) in the exposure time, is low in definition and has other conditions, such as, the image blur and small dynamic range. The exposure time refers to a time period during which the image acquisition device acquires the blurry image. For example, the exposure time of 90 ms refers to a time period of 0-90 ms. While the image acquisition device acquires the blurry image in the exposure time, the event data may be sampled by an event acquisition device (such as an event-based camera) in the exposure time. The event data may reflect a luminance change of a pixel point in the blurry image in the exposure time, and a deblurring processing is then performed on the blurry image with the event data.

The event data may have a format of p_{x,y,t}, where, (x, y) represents a position of a pixel point where the luminance change exceeds a luminance threshold, and t represents a moment when the luminance change of the pixel point (x, y) exceeds the luminance threshold. The value of the p_{x,y,t} represents the luminance change of the pixel point (x, y) at the t moment. For example, when the luminance increase of the pixel point (x, y) at the t moment exceeds the luminance threshold, the value of the p_{x,y,t} is a positive number (such as +1); when the luminance decrease of the pixel point (x, y) at the t moment exceeds the luminance threshold, the value of the p_{x,y,t} is a negative number (such as −1); and when the luminance change of the pixel point (x, y) at the t moment does not reach the luminance threshold, the value of the p_{x,y,t} is 0. The specific value of the luminance threshold may be determined according to an actual condition, which is not specifically limited thereto in the present disclosure.

In a possible implementation, the exposure time includes multiple target moments; and the determining the global event feature in the exposure time according to the event data includes: determining a local event feature corresponding to the i th target moment according to local event data between an i th target moment and an (i+1)th target moment; and determining the global event feature according to local event features corresponding to the multiple target moments.

By determining the multiple target moments in the exposure time of the blurry image, the event data sampled in the exposure time may be divided into multiple groups of event data at an equal time interval, so that the multiple groups of event data may be used to obtain the global event feature and the local event features that reflect scenario motion information in the exposure time. In an example, multiple target moments are determined in the exposure time, and corresponding event data between adjacent target moments is formed as one group of event data, so that local event features corresponding to the multiple target moments for reflecting scenario motion information \may be obtained according to multiple groups of event data, and a global event feature for reflecting the scenario motion information may be obtained according to the local event features corresponding to the multiple target moments.

For example, if the exposure time of the blurry image is 90 ms, the event acquisition device samples the event data in the exposure time, and four target moments are determined in the exposure time: a first target moment (0 ms), a second target moment (30 ms), a third target moment (60 ms) and a fourth target moment (90 ms), the event data may be divided into three groups of event data: local event data between the first target moment and the second target moment (0-30 ms), local event data between the second target moment and the third target moment (30-60 ms), and local event data between the third target moment and the fourth target moment (60-90 ms). A local event feature corresponding to the first target moment may be determined according to the local event data between the first target moment and the second target moment (0-30 ms); a local event feature corresponding to the second target moment may be determined according to the event data between the second target moment and the third target moment (30-60 ms); a local event feature corresponding to the third target moment may be determined according to the event data between the third target moment and the fourth target moment (60-90 ms); and the global event feature in the exposure time (0-90 ms) may be determined according to the local event feature corresponding to the first target moment, the local event feature corresponding to the second target moment and the local event feature corresponding to the third target moment. The number of target moments in the exposure time may be determined according to an actual condition, which is not specifically limited thereto in the present disclosure.

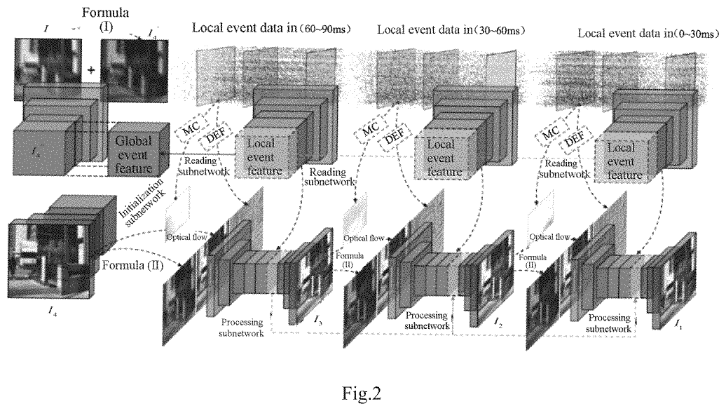

In a possible implementation, the global event feature in the exposure time and the local event features corresponding to the multiple target moments may be determined, according to the event data sampled in the exposure time of the blurry image, by using a reading subnetwork in an image deblurring neutral network. FIG. 2 illustrates a schematic diagram of an image deblurring neutral network according to an embodiment of the present disclosure. The reading subnetwork may be composed of a series of convolutional networks and convolutional long short term memory networks. In FIG. 2, four target moments are included. The event data sampled in the exposure time of the blurry image is input to the reading subnetwork in FIG. 2, and divided into local event data between multiple adjacent target moments at an equal time interval. An encoder composed of a convolutional network performs feature extraction on the local event data between the adjacent target moments to obtain local event features corresponding to the multiple target moments; and then, time sequence feature extraction is performed through the long short term memory network on the local event features corresponding to the multiple target moments to obtain the global event feature in the exposure time. The reading subnetwork may be composed of a series of convolutional networks and convolutional long short term memory networks, and may further be composed of other networks, which is not specifically limited thereto in the present disclosure.

In a possible implementation, the determining the sharp image corresponding to the blurry image according to the blurry image, the event data, and the global event feature includes: determining a sharp image corresponding to the blurry image at a T th target moment according to the blurry image, the event data, and the global event feature.

In a possible implementation, the determining the sharp image corresponding to the blurry image at the T th target moment according to the blurry image, the event data in the exposure, and the global event feature includes: determining, based on a motion blur physical model, an initial sharp image corresponding to the blurry image at the T th target moment according to the blurry image and the event data; and determining the sharp image corresponding to the blurry image at the T th target moment according to the initial sharp image corresponding to the blurry image at the T th target moment and the global event feature.

In the embodiment of the present disclosure, the global event feature for reflecting scenario motion information in the exposure time may be determined according to the event data sampled in the exposure time of the blurry image, such that the sharp image corresponding to the blurry image and having high image quality may be obtained after a deblurring processing is performed on the blurry image based on the event data and the global event feature, thereby effectively improving the image deblurring quality.

Assuming that T frames of sharp images corresponding to the first target moment to the T th target moment in the exposure time may be obtained upon the image deblurring of the blurry image, the blurry image is an image average for the T frames of sharp images according to a motion blur physical model. Hence, an initial sharp image I_{T}′ corresponding to the blurry image at the T target moment is preliminarily determined through the following formula (I) based on the blurry image I and the event data in the exposure time of the blurry image I by using the motion blur physical model:

$$I = \frac{1}{T} {\sum }_{i = 1}^{T} {I}_{i} = {I}_{T}^{\cdot } ⊙ \frac{1}{T} ( 1 + {\sum }_{t = 2}^{T} {\prod }_{i = 1}^{t - 1} {β}_{T - i + 1}^{T - i} ) \\ {β}_{i + 1}^{i} = exp ( - τ {S}_{i + 1}^{i} ) \\ {S}_{i + 1}^{i} ( x , y ) = {\int }_{t = i}^{t = i + 1} {p}_{x , y , i} δ ( {ɛ}_{x , y , i} ) dt . \qquad ( I )$$

Where, T is the number of target moments, Iᵢ is the sharp image corresponding to the blurry image at the i th target moment, τ is the luminance threshold of the event acquisition device, δ(ε_{x,y,t})=1 when the pixel point (x, y) triggers the event ε_{x,y,t} at the t moment, and δ(ε_{x,y,t})=0 when the event ε_{x,y,t} is not triggered. The sharp image corresponding to the blurry image at the T moment is then determined according to the initial sharp image corresponding to the blurry image at the T target moment and the global event feature.

In a possible implementation, the sharp image corresponding to the blurry image at the T moment may be determined according to the blurry image, the event data, and the global event feature by using an initialization subnetwork in the image deblurring neutral network. Still taking the above-described FIG. 2 as an example, the blurry image I and the initial sharp image I₄ corresponding to the blurry image, obtained from the blurry image through the above formula (I), at the fourth target moment are input to an encoder of the initialization subnetwork for encoding to obtain a feature map I₄ corresponding to the fourth target moment; the feature map corresponding to the fourth target moment is then cascaded with the global event feature output by the reading network; and the cascaded feature is decoded by a decoder of the initialization subnetwork to obtain the sharp image (I₄) corresponding to the blurry image at the fourth target moment.

In a possible implementation, the method further includes: determining a sharp image sequence corresponding to the blurry image according to the sharp image corresponding to the blurry image at the T th target moment.

In a possible implementation, the determining the sharp image sequence corresponding to the blurry image according to the sharp image corresponding to the blurry image at the T th target moment includes: determining a sharp image corresponding to the blurry image at the i th target moment according to a sharp image corresponding to the blurry image at the (i+1)th target moment, the local event data between the i th target moment and the (i+1)th target moment, and the local event feature corresponding to the i th target moment, where i=1, 2, . . . , T−1; and obtaining the sharp image sequence according to sharp images corresponding to the blurry image from a first target moment to the T th target moment.

In a possible implementation, the determining a sharp image corresponding to the blurry image at the i th target moment according to a sharp image corresponding to the blurry image at the (i+1)th target moment, the local event data between the i th target moment and the (i+1)th target moment, and the local event feature corresponding to the i th target moment includes: determining an initial sharp image corresponding to the blurry image at the th target moment according to the sharp image corresponding to the blurry image at the (i+1)th target moment, and the local event data between the i th target moment and the (i+1)th target moment; determining a boundary feature map corresponding to the i th target moment by filtering the local event data between the i th target moment and the (i+1)th target moment; and determining the sharp image corresponding to the blurry image at the i th target moment according to the initial sharp image corresponding to the blurry image at the i th target moment and the boundary feature map and the local event feature corresponding to the i th target moment.

Same as the process that the image acquisition device acquires the blurry image, when the event acquisition device acquires the event data in the exposure time of the blurry image, there is also a relative motion between the event acquisition device and the photographed object, which results in a phenomenon that the event data acquired by the event acquisition device at different moments are not aligned. Hence, the local event data between adjacent target moments (such as the local event data between the i th target moment and the (i+1)th target moment) are filtered for alignment. For example, the local event data between the i th target moment and the (i+1)th target moment may be filtered to be aligned the local event data between the i th target moment and the (i+1)th target moment, so as to obtain a clearer boundary feature map corresponding to the i th target moment; and thus, the sharp image having a clearer edge and corresponding to the blurry image at the i th target moment may be obtained according to the initial sharp image corresponding to the blurry image at the i th target moment and the boundary feature map and the local event feature corresponding to the i th target moment.

There are at least the following two modes to determine the initial sharp image corresponding to the blurry image at the i th target moment:

First Mode: Determination Mode Based on Motion Blur Physical Model

In a possible implementation, the determining the initial sharp image corresponding to the blurry image at the i th target moment according to the sharp image corresponding to the blurry image at the (i+1)th target moment and the local event data between the i th target moment and the (i+1)th target moment includes: determining, based on a motion blur physical model, the initial sharp image corresponding to the blurry image at the i th target moment according to the sharp image corresponding to the blurry image at the (i+1)th target moment and the local event data between the i th target moment and the (i+1)th target moment.

In an example, the initial sharp image Iᵢ′ corresponding to the blurry image at the T th target moment is determined through the following formula (II) based on the sharp image Iᵢ₊₁ corresponding to the blurry image at the (i+1)th target moment and the local event data between the i th target moment and the (i+1)th target moment by using the motion blur physical model:

Iᵢ′=Iᵢ₊₁^{⊙}exp)−τSᵢ₊₁ⁱ)

Sᵢ₊₁ⁱ(x,y)=∫ₜ₌₁^{t=i+1}p_{x,y,t}δ(ε_{x,y,t})dt (II).

Second Mode: Determination Mode Based on Optical Flow

In a possible implementation, the determining the initial sharp image corresponding to the blurry image at the i th target moment according to the sharp image corresponding to the blurry image at the (i+1)th target moment and the local event data between the i th target moment and the (i+1)th target moment includes: determining a forward optical flow from the (i+1)th target moment to the i th target moment according to the local event data between the i th target moment and the (i+1)th target moment; and determining the initial sharp image corresponding to the blurry image at the i th target moment according to the sharp image corresponding to the blurry image at the (i+1)th target moment and the forward optical flow.

A spatial position change of the same pixel point between the i th target moment and the (i+1)th target moment is determined according to the local event data between the i th target moment and the (i+1)th target moment, thereby obtaining the forward optical flow from the (i+1)th target moment to the i th target moment; and a motion compensation processing is performed on the sharp image corresponding to the blurry image at the (i+1)th target moment according to the forward optical flow of the (i+1)th target moment to the i th target moment, thereby obtaining the initial sharp image corresponding to the blurry image at the i th target moment.

In a possible implementation, the sharp image sequence corresponding to the blurry image may be determined according to the sharp image corresponding to the blurry image at the T th target moment by using a processing subnetwork in the image deblurring neutral network. Still with the above-described FIG. 2 as an example, at least one of the initial sharp image corresponding to the third target moment obtained by processing the sharp image (I₄) corresponding to the fourth target moment based on the motion blur model (i.e., the formula (II)), the initial sharp image obtained by processing the sharp image (I₄) corresponding to the fourth target moment by using the forward optical flow that is obtained by motion compensation (MC) from the fourth target moment to the third target moment, and the boundary feature map corresponding to the third target moment obtained by filtering the local event data between the third target moment and the fourth target moment with a direction event filtering (DEF) is input to an encoder of the processing subnetwork for encoding so as to obtain a feature map corresponding to the third target moment; the feature map corresponding to the third target moment is then cascaded with the local event feature corresponding to the third target moment output by the reading network; and the cascaded feature is input to a decoder of the processing subnetwork for decoding so as to obtain the sharp image (I₃) corresponding to the blurry image at the third target moment. The mode for determining the sharp image (I₂) corresponding to the blurry image at the second target moment and the sharp image (I₁) corresponding to the blurry image at the first target moment is similar to that for determining the sharp image (I₃) corresponding to the blurry image at the third target moment, and will not be repeated herein.

In the embodiment of the present disclosure, the global event feature and the local event features for reflecting the scenario motion information in the exposure time may be determined according to the event data sampled in the exposure time of a single piece of blurry image; and the sharp image sequence having the high image quality corresponding to the blurry image in the exposure time may be restored from the single piece of blurry image based on the event data, the global event feature, and the local event features, thereby effectively improving the image deblurring quality in the dynamic scenario. For example, the image processing method in the embodiment of the present disclosure may be applied to a photographing system of a mobile terminal device. With the method, the image blur generated by jitter of the camera or movement of the scenario may be removed to obtain the sharp image sequence in photographing, thereby implementing the recording of the dynamic scenario and achieving a better photographing experience for the user. For example, the image processing method provided by the embodiment of the present disclosure may be applied to the vision system of the aircraft, robot or autopilot, such that the image blur generated by the rapid movement may be solved, and the obtained sharp image sequence is also helpful for other vision systems such as the simultaneous localization and mapping (SLAM) to enable better performance.

It will be appreciated that the one or more method embodiments mentioned in the present disclosure may be combined with each other to form a combined embodiment without departing from the principle and logic, which will not be repeated in the present disclosure for the sake of simplicity. It will be appreciated by those skilled in the art that in the method of the specific implementation mode, the specific execution sequence of multiple steps may be determined in terms of the function and possible internal logic.

In addition, the present disclosure further provides an image processing apparatus, an electronic device, a computer-readable storage medium and a program, all of which may be configured to implement any image processing method provided by the present disclosure. The corresponding technical solutions and descriptions refer to the corresponding descriptions in the method and will not be repeated herein.

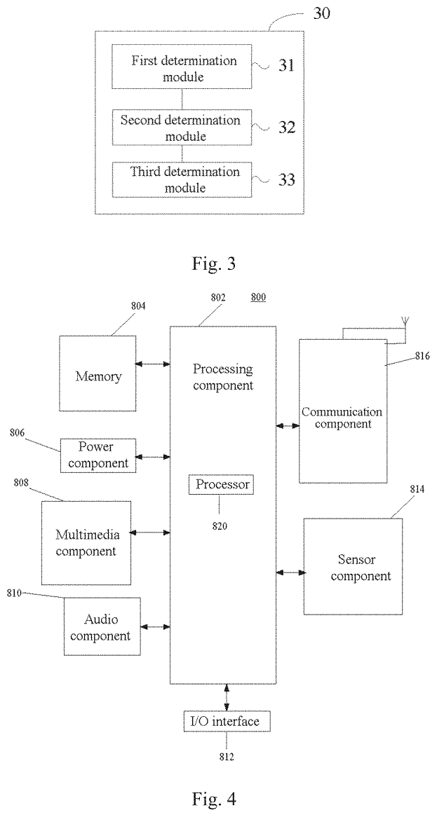

FIG. 3 illustrates a block diagram of an image processing apparatus according to an embodiment of the present disclosure. As shown in FIG. 3, the apparatus 30 includes:

a first determination module 31, configured to acquire a blurry image exposed in exposure time and event data sampled in the exposure time, wherein the event data is configured to reflect a luminance change of a pixel point in the blurry image;

a second determination module 32, configured to determine a global event feature in the exposure time according to the event data; and

a third determination module 33, configured to determine a sharp image corresponding to the blurry image according to the blurry image, the event data, and the global event feature.

In a possible implementation, the exposure time includes multiple target moments; and

the second determination module 32 includes:

a first determination submodule, configured to determine, according to local event data between an i th target moment and an (i+1)th target moment, a local event feature corresponding to the i th target moment, where i=1, 2, . . . , T−1; and

a second determination submodule, configured to determine the global event feature according to local event features corresponding to the multiple target moments.

In a possible implementation, the third determination module 33 includes:

a third determination submodule, configured to determine a sharp image corresponding to the blurry image at a T th target moment according to the blurry image, the event data, and the global event feature.

In a possible implementation, the third determination submodule includes:

a first determination unit, configured to determine, based on a motion blur physical model an initial sharp image corresponding to the blurry image at the T th target moment according to the blurry image and the event data; and a second determination unit, configured to determine the sharp image corresponding to the blurry image at the T th target moment according to the initial sharp image corresponding to the blurry image at the T th target moment and the global event feature.

In a possible implementation, the third determination module 33 further includes:

a fourth determination submodule, configured to determine, according to the sharp image corresponding to the blurry image at the T th target moment, a sharp image sequence corresponding to the blurry image.

In a possible implementation, the fourth determination submodule includes:

a third determination unit, configured to determine a sharp image corresponding to the blurry image at the i th target moment according to a sharp image corresponding to the blurry image at the (i+1)th target moment, the local event data between the i th target moment and the (i+1)th target moment, and the local event feature corresponding to the i th target moment, where i=1, 2, . . . , T−1; and

a fourth determination unit, configured to obtain the sharp image sequence according to sharp images corresponding to the blurry images from a first target moment to the T th target moment.

In a possible implementation, the third determination unit includes:

a first determination subunit, configured to determine an initial sharp image corresponding to the blurry image at the i th target moment according to the sharp image corresponding to the blurry image at the (i+1)th target moment and the local event data between the i th target moment and the (i+1)th target moment;
a second determination subunit, configured to determine, by filtering the local event data between the i target moment and the (i+1)th target moment, a boundary feature map corresponding to the i th target moment; and

a third determination subunit, configured to determine the sharp image corresponding to the blurry image at the i th target moment according to the initial sharp image corresponding to the blurry image at the i th target moment and the boundary feature map and the local event feature corresponding to the i th target moment.

In a possible implementation, the first determination subunit is specifically configured to:

determine, based on a motion blur physical model, the initial sharp image corresponding to the blurry image at the i th target moment according to the sharp image corresponding to the blurry image at the (i+1)th target moment and the local event data between the i th target moment and the (i+1)th target moment.

In a possible implementation, the first determination subunit is specifically configured to:

determine a forward optical flow from the (i+1)th target moment to the i th target moment according to the local event data between the i th target moment and the (i+1)th target moment; and

determine, according to the sharp image corresponding to the blurry image at the (i+1)th target moment and the forward optical flow, the initial sharp image corresponding to the blurry image at the i th target moment.

In some embodiments, functions or modules of the apparatus provided in the embodiments of the present disclosure may be configured to execute the method described in the above method embodiments, which may be specifically implemented by referring to the above descriptions of the method embodiments, and are not repeated here for brevity.

An embodiment of the present disclosure further provides a computer-readable storage medium having computer program instructions stored thereon, wherein the computer program instructions, when executed by a processor, implement the above method. The computer-readable storage medium may be a non-volatile computer-readable storage medium.

An embodiment of the present disclosure further provides an electronic device, which includes: a processor; and a memory, configured to store processor executable instructions, wherein the processor is configured to call the instructions stored in the memory to execute the above method.

An embodiment of the present disclosure further provides a computer program product, which includes computer-readable codes; and when the computer-readable codes run on a device, a processor in the device executes the instructions for implementing the image processing method as provided in any of the above embodiments.

An embodiment of the present disclosure further provides another computer program product, which is configured to store computer readable instructions; and the instructions are executed to cause the computer to perform the operation of the image processing method as provided in any one of the above embodiments.

The electronic device may be provided as a terminal, a server or a device in any other form.

FIG. 4 illustrates a block diagram of an electronic device 800 according to an embodiment of the present disclosure. For example, the electronic device 800 may be a mobile phone, a computer, a digital broadcast terminal, a message transceiver, a game console, a tablet device, medical equipment, fitness equipment, a personal digital assistant or any other terminal.

Referring to FIG. 4, the electronic device 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls overall operations of the electronic device 800, such as operations related to display, phone call, data communication, camera operation and record operation. The processing component 802 may include one or more processors 820 to execute instructions so as to complete all or some steps of the above method. Furthermore, the processing component 802 may include one or more modules for interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of these data include instructions for any application or method operated on the electronic device 800, contact data, telephone directory data, messages, pictures, videos, etc. The memory 804 may be any type of volatile or non-volatile storage devices or a combination thereof, such as static random access memory (SRAM), electronic erasable programmable read-only memory (EEPROM), erasable programmable read-only memory (EPROM), read-only memory (ROM), a magnetic memory, a flash memory, a magnetic disk or a compact disk.

The power supply component 806 supplies electric power to various components of the electronic device 800. The power supply component 806 may include a power supply management system, one or more power supplies, and other components related to the power generation, management and allocation of the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, sliding, and gestures on the touch panel. The touch sensor may not only sense a boundary of the touch or sliding action, but also detect the duration and pressure related to the touch or sliding operation. In some embodiments, the multimedia component 808 includes a front camera and/or a rear camera. When the electronic device 800 is in an operating mode such as a shooting mode or a video mode, the front camera and/or the rear camera may receive external multimedia data. Each front camera and rear camera may be a fixed optical lens system or have a focal length and optical zooming capability.

The audio component 810 is configured to output and/or input an audio signal. For example, the audio component 810 includes a microphone (MIC). When the electronic device 800 is in the operating mode such as a call mode, a record mode and a voice identification mode, the microphone is configured to receive the external audio signal. The received audio signal may be further stored in the memory 804 or sent by the communication component 816. In some embodiments, the audio component 810 also includes a loudspeaker which is configured to output the audio signal.

The I/O interface 812 provides an interface between the processing component 802 and a peripheral interface module. The peripheral interface module may be a keyboard, a click wheel, buttons, etc. These buttons may include but are not limited to home buttons, volume buttons, start buttons and lock buttons.

The sensor component 814 includes one or more sensors which are configured to provide state evaluation in various aspects for the electronic device 800. For example, the sensor component 814 may detect an on/off state of the electronic device 800 and relative positions of the components such as a display and a small keyboard of the electronic device 800. The sensor component 814 may also detect the position change of the electronic device 800 or a component of the electronic device 800, presence or absence of a user contact with electronic device 800, directions or acceleration/deceleration of the electronic device 800 and the temperature change of the electronic device 800. The sensor component 814 may include a proximity sensor configured to detect the presence of nearby objects without any physical contact. The sensor component 814 may further include an optical sensor such as a CMOS or CCD image sensor which is used in an imaging application. In some embodiments, the sensor component 814 may further include an acceleration sensor, a gyroscope sensor, a magnetic sensor, a pressure sensor or a temperature sensor.

The communication component 816 is configured to facilitate the communication in a wire or wireless manner between the electronic device 800 and other devices. The electronic device 800 may access a wireless network based on communication standards, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to promote the short range communication. For example, the NFC module may be implemented on the basis of radio frequency identification (RFID) technology, infrared data association (IrDA) technology, ultrawide band (UWB) technology, Bluetooth (BT) technology and other technologies.

In exemplary embodiments, the electronic device 800 may be implemented by one or more application dedicated integrated circuits (ASIC), digital signal processors (DSP), digital signal processing device (DSPD), programmable logic device (PLD), field programmable gate array (FPGA), controllers, microcontrollers, microprocessors or other electronic elements and is used to execute the above method.

In an exemplary embodiment, there is further provided a non-volatile computer readable storage medium, such as a memory 804 including computer program instructions. The computer program instructions may be executed by a processor 820 of an electronic device 800 to implement the above method.

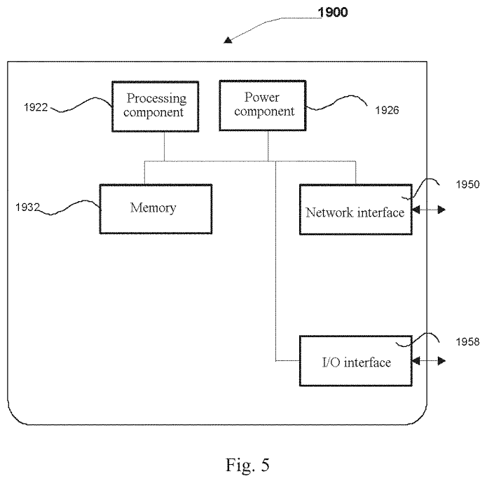

FIG. 5 illustrates a block diagram of an electronic device 1900 according to an embodiment of the present disclosure. For example, the electronic device 1900 may be provided as a server. Referring to FIG. 5, the electronic device 1900 includes a processing component 1922, and further includes one or more processors and memory resources represented by a memory 1932 and configured to store instructions executed by the processing component 1922, such as an application program. The application program stored in the memory 1932 may include one or more modules each corresponding to a group of instructions. Furthermore, the processing component 1922 is configured to execute the instructions so as to execute the above method.

The electronic device 1900 may further include a power supply component 1926 configured to perform power supply management on the electronic device 1900, a wire or wireless network interface 1950 configured to connect the electronic device 1900 to a network, and an input/output (I/O) interface 1958. The electronic device 1900 may run an operating system stored in the memory 1932, such as Windows Server™, Mac OS X™, Unix™, Linux™, FreeBSD™ or the like.

In an exemplary embodiment, there is further provided a non-volatile computer readable storage medium, such as a memory 1932 including computer program instructions. The computer program instructions may be executed by a processing module 1922 of an electronic device 1900 to execute the above method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium may be a tangible device that may retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein may be downloaded to individual computing/processing devices from a computer readable storage medium or to an external computer or external storage device via network, for example, the Internet, local region network, wide region network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local region network (LAN) or wide region network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; and the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, may be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, may be implemented by dedicated hardware-based systems performing the specified functions or acts, or by combinations of dedicated hardware and computer instructions.

The computer program product may be implemented specifically by hardware, software or a combination thereof. In an optional embodiment, the computer program product is specifically embodied as a computer storage medium. In another optional embodiment, the computer program product is specifically embodied as a software product, such as software development kit (SDK) and the like.

On the premise of not violating the logic, different embodiments of the present disclosure may be combined with one another. Different embodiments may describe different aspects. For the emphasized description, please refer to the records of other embodiments.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. An image processing method, comprising:
acquiring a blurry image exposed in exposure time and event data sampled in the exposure time, wherein the event data is configured to reflect a luminance change of a pixel point in the blurry image;
determining a global event feature in the exposure time according to the event data; and
determining a sharp image corresponding to the blurry image according to the blurry image, the event data, and the global event feature.

2. The method according to claim 1, wherein the exposure time includes multiple target moments; and
said determining a global event feature in the exposure time according to the event data includes:
determining, according to local event data between an i th target moment and an (i+1)th target moment, a local event feature corresponding to the i th target moment, wherein i=1, 2, . . . , T−1; and
determining the global event feature according to local event features corresponding to the multiple target moments.

3. The method according to claim 2, wherein said determining a sharp image corresponding to the blurry image according to the blurry image, the event data, and the global event feature includes:
determining a sharp image corresponding to the blurry image at a T th target moment according to the blurry image, the event data, and the global event feature.

4. The method according to claim 3, wherein said determining a sharp image corresponding to the blurry image at a T th target moment according to the blurry image, the event data, and the global event feature includes:
determining, based on a motion blur physical model, an initial sharp image corresponding to the blurry image at the T th target moment according to the blurry image and the event data; and
determining the sharp image corresponding to the blurry image at the T th target moment according to the initial sharp image corresponding to the blurry image at the T th target moment and the global event feature.

5. The method according to claim 3, further comprising:
determining a sharp image sequence corresponding to the blurry image according to the sharp image corresponding to the blurry image at the T th target moment.

6. The method according to claim 5, wherein said determining a sharp image sequence corresponding to the blurry image according to the sharp image corresponding to the blurry image at the T th target moment includes:
determining a sharp image corresponding to the blurry image at the i th target moment according to a sharp image corresponding to the blurry image at the (i+1)th target moment, the local event data between the i th target moment and the (i+1)th target moment, and the local event feature corresponding to the i th target moment, wherein i=1, 2, . . . , T−1; and
obtaining the sharp image sequence according to sharp images corresponding to the blurry images from a first target moment to the T th target moment.

7. The method according to claim 6, wherein said determining a sharp image corresponding to the blurry image at the i th target moment according to a sharp image corresponding to the blurry image at the (i+1)th target moment, the local event data between the i th target moment and the (i+1)th target moment, and the local event feature corresponding to the i th target moment includes:
determining an initial sharp image corresponding to the blurry image at the i th target moment according to the sharp image corresponding to the blurry image at the (i+1)th target moment and the local event data between the i th target moment and the (i+1)th target moment;
determining, by filtering the local event data between the i th target moment and the (i+1)th target moment, a boundary feature map corresponding to the i th target moment; and
determining the sharp image corresponding to the blurry image at the i th target moment according to the initial sharp image corresponding to the blurry image at the i th target moment and the boundary feature map and the local event feature corresponding to the i th target moment.

8. The method according to claim 7, wherein said determining an initial sharp image corresponding to the blurry image at the i th target moment according to the sharp image corresponding to the blurry image at the (i+1)th target moment and the local event data between the i th target moment and the (i+1)th target moment includes:
determining the initial sharp image corresponding to the blurry image at the i th target moment based on a motion blur physical model, according to the sharp image corresponding to the blurry image at the (i+1)th target moment and the local event data between the i th target moment and the (i+1)th target moment.

9. The method according to claim 7, wherein said determining an initial sharp image corresponding to the blurry image at the i th target moment according to the sharp image corresponding to the blurry image at the (i+1)th target moment and the local event data between the i th target moment and the (i+1)th target moment includes:
determining a forward optical flow from the (i+1)th target moment to the i th target moment according to the local event data between the i th target moment and the (i+1)th target moment; and
determining, according to the sharp image corresponding to the blurry image at the (i+1)th target moment and the forward optical flow, the initial sharp image corresponding to the blurry image at the i th target moment.

10. The method according to claim 4, further comprising:
determining a sharp image sequence corresponding to the blurry image according to the sharp image corresponding to the blurry image at the T th target moment.

11. An image processing device, comprising:
a processor; and
a memory configured to store processor executable instructions,
wherein the processor is configured to execute instructions stored by the memory, so as to:
acquire a blurry image exposed in exposure time and event data sampled in the exposure time, wherein the event data is configured to reflect a luminance change of a pixel point in the blurry image;
determine a global event feature in the exposure time according to the event data; and
determine a sharp image corresponding to the blurry image according to the blurry image, the event data, and the global event feature.

12. The image processing device according to claim 11, wherein the exposure time includes multiple target moments; and
said determining a global event feature in the exposure time according to the event data includes:
determining, according to local event data between an i th target moment and an (i+1)th target moment, a local event feature corresponding to the i th target moment, wherein i=1, 2, . . . , T−1; and
determining the global event feature according to local event features corresponding to the multiple target moments.

13. The image processing device according to claim 12, wherein said determining a sharp image corresponding to the blurry image according to the blurry image, the event data, and the global event feature includes:
determining a sharp image corresponding to the blurry image at a T th target moment according to the blurry image, the event data, and the global event feature.

14. The image processing device according to claim 13, wherein said determining a sharp image corresponding to the blurry image at a T th target moment according to the blurry image, the event data, and the global event feature includes:
determining, based on a motion blur physical model, an initial sharp image corresponding to the blurry image at the T th target moment according to the blurry image and the event data; and
determining the sharp image corresponding to the blurry image at the T th target moment according to the initial sharp image corresponding to the blurry image at the T th target moment and the global event feature.

15. The image processing device according to claim 13, the processor is further configured to:
determine a sharp image sequence corresponding to the blurry image according to the sharp image corresponding to the blurry image at the T th target moment.

16. The image processing device according to claim 15, wherein said determining a sharp image sequence corresponding to the blurry image according to the sharp image corresponding to the blurry image at the T th target moment includes:
determining a sharp image corresponding to the blurry image at the i th target moment according to a sharp image corresponding to the blurry image at the (i+1)th target moment, the local event data between the i th target moment and the (i+1)th target moment, and the local event feature corresponding to the i th target moment, wherein i=1, 2 . . . , T−1; and
obtaining the sharp image sequence according to sharp images corresponding to the blurry images from a first target moment to the T th target moment.

17. The image processing device according to claim 16, wherein said determining a sharp image corresponding to the blurry image at the i th target moment according to a sharp image corresponding to the blurry image at the (i+1)th target moment, the local event data between the i th target moment and the (i+1)th target moment, and the local event feature corresponding to the i th target moment includes:
determining an initial sharp image corresponding to the blurry image at the i th target moment according to the sharp image corresponding to the blurry image at the (i+1)th target moment and the local event data between the i th target moment and the (i+1)th target moment;
determining, by filtering the local event data between the i th target moment and the (i+1)th target moment, a boundary feature map corresponding to the i th target moment; and
determining the sharp image corresponding to the blurry image at the i th target moment according to the initial sharp image corresponding to the blurry image at the i th target moment and the boundary feature map and the local event feature corresponding to the i th target moment.

18. The image processing device according to claim 17, wherein said determining an initial sharp image corresponding to the blurry image at the i th target moment according to the sharp image corresponding to the blurry image at the (i+1)th target moment and the local event data between the i th target moment and the (i+1)th target moment includes:
determining the initial sharp image corresponding to the blurry image at the i th target moment based on a motion blur physical model, according to the sharp image corresponding to the blurry image at the (i+1)th target moment and the local event data between the i th target moment and the (i+1)th target moment.

19. The image processing device according to claim 17, wherein said determining an initial sharp image corresponding to the blurry image at the i th target moment according to the sharp image corresponding to the blurry image at the (i+1)th target moment and the local event data between the i th target moment and the (i+1)th target moment includes:
determining a forward optical flow from the (i+1)th target moment to the i th target moment according to the local event data between the i th target moment and the (i+1)th target moment; and
determining, according to the sharp image corresponding to the blurry image at the (i+1)th target moment and the forward optical flow, the initial sharp image corresponding to the blurry image at the i th target moment.

20. A non-transitory computer-readable storage medium having computer program instructions stored thereon, wherein the computer program instructions, when executed by a processor, implement steps of:
acquiring a blurry image exposed in exposure time and event data sampled in the exposure time, wherein the event data is configured to reflect a luminance change of a pixel point in the blurry image;
determining a global event feature in the exposure time according to the event data; and
determining a sharp image corresponding to the blurry image according to the blurry image, the event data, and the global event feature.
